(19) United States
(12) Patent Application Publication
(10) Pub. No.: US 2004/0161212 A1
(43) Pub. Date: Aug. 19, 2004

(54) Fiber optic apparatus

(76) Inventors: Maurice X. Sun, Naperville, IL (US); Igor Grois, Northbrook, IL (US)

Correspondence Address: MOLEX INCORPORATED, 2222 WELLINGTON COURT, LISLE, IL, 60532, US

(21) Appl. No.: 10/371,327

(22) Filed: Feb. 18, 2003

(51) Int. Cl. G02B 6/44

(52) U.S. Cl. 385/114

(57) ABSTRACT

A fiber optic apparatus is provided for cross-connecting the individual fibers of a plurality of fiber optic ribbons. The apparatus includes a flat substrate having plurality of individual optical fibers routed thereon. The fibers are routed to form at least one first fiber optic ribbon leading onto the substrate at a first edge location thereof and at least one second fiber optic ribbon leading away from the substrate at a second edge location thereof. The fibers and ribbons follow a uniform path between the edge locations. An inner portion of at least one of the fiber optic ribbons on the substrate is routed with a loop offset form the uniform path to provide an amount of slack to allow an outer portion of the ribbon off of the substrate to be varied in length.

### FIELD OF THE INVENTION

This invention generally relates to the art of optical fibers and, particularly, to a fiber optic apparatus for cross-connecting the individual fibers of a plurality of fiber optic ribbons.

### BACKGROUND OF THE INVENTION

Fiber optic circuitry is increasingly being used in electronics systems where circuit density is ever-increasing and is difficult to provide with known electrically wired circuitry. An optical fiber circuit is formed by a plurality of optical fibers carried by a dielectric, and the ends of the fibers are interconnected to various forms of connectors or other optical transmission devices. A fiber optic circuit may range from a simple cable which includes a plurality of optical fibers surrounded by an outer cladding or tubular dielectric to a more sophisticated optical backplane or flat fiber optic circuit formed by a plurality of optical fibers mounted on a substrate in a given pattern or circuit geometry.

One type of optical fiber circuit is produced in a ribbonized configuration wherein a row of optical fibers are disposed in a side-by-side parallel array and coated with a matrix to hold the fibers in the ribbonized configuration. This often is called “ribbonizing” In the United States, an eight-fiber ribbon or a twelve-fiber ribbon have become common. In other foreign countries, the standard may range from as a low as four to as high as twenty-four fibers per ribbon. Multi-fiber ribbons and connectors have a wide range of applications in fiber optic communication systems. For instance, optical splitters, optical switches, routers, combiners and other systems have input fiber optic ribbons and output fiber optic ribbons.

With various applications such as those described above, the individual optical fibers of input fiber optic ribbons and output fiber optic ribbons are cross-connected or reorganized whereby the individual optical fibers of a single input ribbon may be separated and reorganized into multiple or different output ribbons. The individual optical fibers are cross-connected or reorganized in what has been called a “mixing zone” between the input and output ribbons.

Optical backplanes are fabricated in a variety of manners, ranging from laying the optical fibers on a substrate by hand to routing the optical fibers in a given pattern or circuit geometry onto the substrate by mechanized apparatus. The individual optical fibers are cross-connected or reorganized on the substrate between input and output ribbons projecting from input and output ends or edges of the substrate. Therefore, the above-mentioned “mixing zone” is provided by the substrate, itself. The input and/or output ribbons which project from the edges of the substrate then are cut-off at predetermined lengths according to the backplane specifications and are terminated to a plurality of fiber optic connectors.

A problem continues to be encountered when the input and/or output ribbons which project from the substrate are terminated to fiber optic connectors or other connecting devices. As stated above, the ribbons are cut-off to particular backplane specifications before they are terminated to the fiber optic connectors. In other words, the lengths of the ribbons which project away from the substrate are predetermined in order to provide generally straight ribbons so that the ribbons are not bent or buckled when installed for a particular usage of the fiber optic apparatus. Buckled or bent ribbons are prone to breakage and they take up too much space or “real estate” in very high dense or compact applications.

The problem occurs when a mistake or error is made in terminating one or more of the fiber optic connectors to the ribbons which project from the edges of the substrate. If an incorrect termination is made, the connector is removed and the ribbon must re-cut and re-terminated. Consequently, manufacturers have built in a tolerance in the length of the ribbons, such as ±10 millimeters in ribbon length. Unfortunately, this tolerance only accommodates a single re-termination, at most. If another error occurs, the entire fiber optic apparatus, including the substrate and multiple input/output ribbons, is discard and wasted. The present invention is directed to solving these problems by providing a fiber optic apparatus which has a built-in “slack” in the ribbons on the substrate which is sufficient to allow for multiple re-terminations if necessary.

### SUMMARY OF THE INVENTION

An object, therefore, of the invention is to provide a new and improved fiber optic apparatus for cross-connecting the individual fibers of a plurality of fiber optic ribbons.

In the exemplary embodiment of the invention, the apparatus includes a flat substrate with a plurality of individual optical fibers routed on the substrate. The individual fibers are routed to form at least one first fiber optic ribbon leading onto one side of the substrate. The fibers are reorganized on the substrate to form a plurality of second fiber optic ribbons leading away from another side of the substrate. An inner portion of at least one of the second fiber optic ribbons on the substrate is provided with an amount of slack to allow an outer portion of the second ribbon off of the substrate to be varied in length.

As disclosed herein, the substrate is provided with a releasable adhesive for adhering the optical fibers to the substrate. A strippable coating is provided over the optical fibers on the substrate. If it is necessary to re-terminate the second fiber optic ribbons, the ribbon is partially stripped from the substrate to take up sufficient slack to allow the ribbon to be at a predetermined length and the stripped ribbons is re-adhered to the substrate and re-coated.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a plan view of a fiber optic apparatus according to the prior art; and

FIG. 2 is a plan view of a fiber optic apparatus according to the invention.

### DETAILED DESCRIPTION OF THE PREFERRED EMBODIMENT

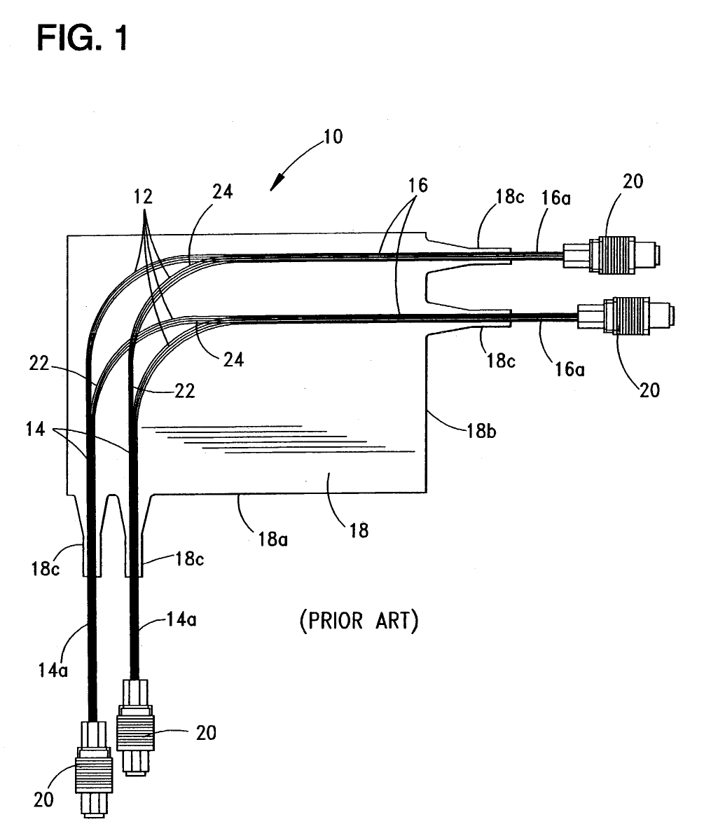

Referring to the drawings in greater detail, and first to FIG. 1, a fiber optic apparatus, generally designated 10, is shown for cross-connecting individual fibers 12 of a plurality of fiber optic ribbons 14 and 16. The individual optical fibers are routed on a substrate 18 in a side-by-side array to form a plurality of first fiber optic ribbons 14 leading onto one side or edge 18a of the substrate. The fibers are re-organized on the substrate to form a plurality of second fiber optic ribbons 16 which lead away from another side or edge 18b of the substrate. The fibers are routed onto and off of tail portions 18c of the substrate which project outwardly from sides or edges 18a and 18b. With the arrangement of FIG. 1, first fiber optic ribbons 14 may be considered input ribbons, as at 14a, and second fiber optic ribbons 16 may be considered output ribbons, as at 16a. The input ribbons and output ribbons project away from edges 18a and 18b of the substrate, particularly along and off of tail portions 18c of the substrate, and are terminated to a plurality of fiber optic connectors 20.

As stated above, input ribbons 14/14a are reorganized on substrate 18 to form output ribbons 16/16a. In the example shown in FIG. 1, the input ribbons are split, as at 22, with one-half of each input ribbon joining one-half of the other input ribbon, as at 24, to form each of the output ribbons. In the illustrated embodiment, each input ribbon has eight individual optical ribbons which are split, as at 22, with four of the fibers being joined with four fibers of the other input ribbon, as at 24, to form each of the output ribbons.

Substrate 18 typically has a layer of adhesive on the top surface thereof, and the routed individual optical fibers 12 readily adhere to the surface of the substrate to maintain their position thereon. The individual fibers may be routed by hand or by a mechanized device which typically is computerized. After the individual fibers are properly routed and adhered to the substrate in a particular circuit geometry, such as the geometry shown in FIG. 1 and described above, a conformal coating is applied over the substrate and the routed fibers. The coating also may be applied to the fibers of input ribbons 14a and output ribbons 16a, off the substrate, to hold the ribbons in their ribbonized configurations.

Input and output ribbons 14a and 16a, respectively, are shown terminated to fiber optic connectors 20. In actual practice, ribbons 14a and 16a are cut to fairly restricted or prescribed lengths. As stated in the “Background”, above, this is done so that when apparatus 10 is installed in a particular fiber optic application, the ribbons are maintained as straight as possible in order to avoid bending or buckling of the ribbons, and also to avoid taking up valuable space or “real estate” in a dense or compact application, such as is encountered in many backplane usages.

With the above understanding of the structure, manufacture and usage of the prior art fiber apparatus 10 as described above, it can be understood that problems are encountered if there is an error or mistake in the termination of any of the input or output ribbons 14a and 16a, respectively, to connectors 12. It should be understood that if a mistake is made in terminating one of the ribbons, the ribbon must be re-cut in order to provide a clean end for a subsequent re-termination. In order to accommodate such possible re-terminations, manufacturers have built in a tolerance, such as ±10 millimeters, in the lengths of ribbons 14a and/or 16a. Unfortunately, this built-in tolerance may accommodate only one re-termination. Any additional built-in tolerances would make ribbons 14a and/or 16a unacceptably long because of the bending and space problems described above.

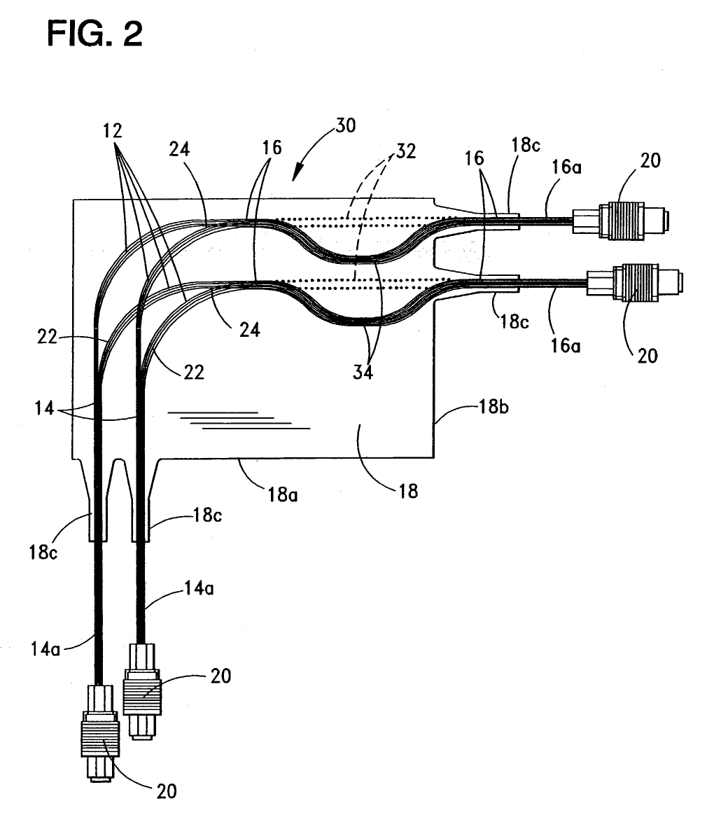

In order to solve the problems described immediately above and in the preceding “Background”, a fiber optic apparatus, generally designated 30, has been designed according to the invention and is shown in FIG. 2. Like reference numerals have been applied in FIG. 2 corresponding to like components described above and shown in FIG. 1, in order to avoid duplicity of description or explanation. With that understanding, the position of output ribbons 16 shown in FIG. 1 and described above, is shown by dotted lines 32 in FIG. 2.

Generally, the invention contemplates that one or more of the fiber optic ribbons be provided with an amount of slack to allow an outer portion (e.g., 14a and/or 16a) of the ribbon off of substrate 18 to be varied in length and, thereby, accommodate multiple re-terminations with connectors 20, if necessary. Specifically, FIG. 2 shows that each output ribbon 16 is routed on substrate 18 to form a loop 34 which is offset from the normal uniform path 32 (dotted lines) of the output ribbons. The use of the term “uniform path” herein and in the claims hereof is meant to describe a normal path of routing individual optical fibers on a substrate, such as described above in regard to the prior art apparatus 10 in FIG. 1. Although the uniform paths shown herein are generally right-angled, other circuit geometries are contemplated, such as straight lines, U-shaped paths, or the like, keeping in mind that there are restrictions in the amount of bending that can be achieved with tiny optical fibers which are relatively stiff and brittle. Typically, a uniform path is the most logical or rational path for routing the fibers from one side or edge of the substrate to another side or edge thereof. In the embodiment herein, with the fibers being routed onto edge 18a and routed off of edge 18b, since the edges are at a right-angle to each other, individual fibers 12 logically are routed in a uniform right-angled geometry without abrupt changes, as is shown. In other words, loops 34 (FIG. 2) are provided to offset the fibers out of their normal or rational uniform path to provide an amount of slack that can be used to lengthen ribbons 14a and/or 16a if necessary to provide sufficient re-terminations with connectors 20. In addition, while loops 34 are shown in output ribbons 16, the loops also may be provided in input ribbons 14 or in both the input and output ribbons.

If an operator makes a mistake or discovers a malfunction in the termination of one of the ribbons with its respective connector 20, such as the top output ribbon 16a with its respective connector, the top output ribbon simply is stripped away from substrate 18 at least into the respective loop 34 of the ribbon. To this end, the adhesive on substrate 18 should be a releasable adhesive, and the conformal coating over the fibers and the substrate should be a strippable coating. Once the ribbon is stripped from the substrate, output ribbon 16a can be lengthened, cut-off to a length according to specifications, and re-terminated to a respective connector 20. If that re-termination is successful, output ribbon 16/16a then is re-positioned onto the top of substrate 18 by additional adhesive, and additional conformal coating material can be applied over the re-positioned loop and fibers. This procedure is considerably less expensive than having to discard and waste the entire substrate 18 and the fibers routed thereon. In fact, some connectors 20 may be permanently affixed to the ribbons when terminated. In the embodiment illustrated, if three connectors already have been properly terminated, and an error occurs in the fourth connector, it would be very expensive to discard the entire apparatus including all of the previously, permanently terminated connectors. With the invention, the fourth ribbon simply is re-terminated using the slack in loop 34, and the entire apparatus is saved.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A fiber optic apparatus for cross-connecting the individual fibers of a plurality of fiber optic ribbons, comprising:
a substrate;
a plurality of individual optical fibers routed on the substrate to form at least one first fiber optic ribbon leading onto one side of the substrate, the fibers being reorganized on the substrate to form a plurality of second fiber optic ribbons leading away from another side of the substrate; and
an inner portion of at least one of said second fiber optic ribbons on the substrate being provided with an amount of slack to allow an outer portion of said at least one of the second fiber optic ribbons off of the substrate to be varied in length.

2. The fiber optic apparatus of claim 1, wherein said substrate is generally flat.

3. The fiber optic apparatus of claim 1 wherein said substrate is provided with a releasable adhesive for adhering the optical fibers to the substrate.

4. The fiber optic apparatus of claim 1, including a strippable coating over the optical fibers on the substrate.

5. The fiber optic apparatus of claim 1 wherein said substrate is provided with a releasable adhesive for adhering the optical fibers to the substrate, along with a strippable coating over the adhered optical fibers on the substrate.

6. The fiber optic apparatus of claim 1, including a fiber optic connector terminated to each of the second fiber optic ribbons off of the substrate.

7. A fiber optic apparatus for cross-connecting the individual fibers of a plurality of fiber optic ribbons, comprising:
a substrate;
a plurality of individual optical fibers routed on the substrate to form at least one first fiber optic ribbon leading onto the substrate at a first edge location of the substrate, and at least one second fiber optic ribbon leading away from the substrate at a second edge location of the substrate, the fibers and ribbons following a uniform path between said edge locations; and
an inner portion of at least one of said fiber optic ribbons on the substrate being routed with a loop offset from said uniform path to provide an amount of slack to allow an outer portion of said at least one of the fiber optic ribbons off of the substrate to be varied in length.

8. The fiber optic apparatus of claim 7 wherein said substrate is generally flat.

9. The fiber optic apparatus of claim 6 wherein said substrate is provided with a releasable adhesive for adhering the optical fibers to the substrate.

10. The fiber optic apparatus of claim 7, including a strippable coating over the optical fibers on the substrate.

11. The fiber optic apparatus of claim 7 wherein said substrate is provided with a releasable adhesive for adhering the optical fibers to the substrate, along with a strippable coating over the adhered optical fibers on the substrate.

12. The fiber optic apparatus of claim 7, including a fiber optic connector terminated to said at least one of the fiber optic ribbons off of the substrate.
